(19) United States
(12) Patent Application Publication
(10) Pub. No.: US 2014/0059935 A1
(43) Pub. Date: Mar. 6, 2014

(54) Manual Window Regulator Device

(71) Applicant: HYUNDAI MOTOR COMPANY, Seoul (KR)

(72) Inventors: Dong Wuk Choi, Yongin-si (KR); Kyoung Taek Kwak, Yongin-si (KR)

(73) Assignee: Hyundai Motor Company, Seoul (KR)

(21) Appl. No.: 13/710,405

(22) Filed: Dec. 10, 2012

(30) Foreign Application Priority Data
Sep. 4, 2012 (KR) 10-2012-0097781

(51) Int. Cl. E05F 11/50

(52) U.S. Cl. CPC E05F 11/505
USPC 49/363

(57) ABSTRACT

A manual window regulator device may include a drum, handle shafts provided at opposing sides of an inner portion of the drum and each handle shaft including a catching part protrudedly formed at an inner side thereof, a glass shaft rotatably provided substantially at the center of the drum and fixed to the catching parts of the handle shafts while being caught by the catching parts at time of a left or right turn, and roller parts provided at an upper portion, a lower portion, or upper and lower portions of the drum, and fixing the handle shafts while being fitted between the handle shafts and the drum at time of rotation of the handle shafts.

### CROSS-REFERENCE TO RELATED APPLICATION

The present application claims priority of Korean Patent Application Number 10-2012-0097781, filed on Sep. 4, 2012, the entire contents of which application is incorporated herein for all purposes by this reference.

### BACKGROUND OF INVENTION

1. Field of Invention

The present invention relates to a manual window regulator device, and more particularly, to a manual window regulator device capable of preventing sliding of glass outside a vehicle.

2. Description of Related Art

Generally, a drive unit of a manual window regulator is provided with a brake function so as to raise or lower glass by handle manipulation inside a vehicle and so as not to directly move the glass outside the vehicle.

The brake function according to the related art as described above is implemented using frictional force between a steel housing and a brake spring. However, since the friction force is used, a problem such as insufficient braking force or noise due to friction has been continuously generated.

Given the above background, there is a need to solve at least some or all of the above-mentioned problems occurring in the prior art while advantages achieved by the prior art are maintained intact.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are directed to provide a manual window regulator device capable of increasing braking force and preventing generation of noise by implementing a brake function using a roller.

Various aspects of the present invention provide a manual window regulator device including a drum, handle shafts provided at both sides of an inner portion of the drum and each handle shaft including a catching part protrudedly formed at an inner side thereof, a glass shaft rotatably provided substantially at the center of the drum and fixed to the catching parts of the handle shafts while being caught by the catching parts at time of a left or right turn, and roller parts provided one o more of the drum, and fixing the handle shafts while being fitted between the handle shafts and the drum at time of rotation of the handle shafts.

Each roller part may include a roller and a roller guide in which the roller is rotatably provided.

When the glass shaft is rotated, the roller parts may be gradually fitted between the glass shaft and the drum, thereby stopping further rotation of the glass shaft.

When the handle shaft is rotated, the handle shafts may simultaneously push both of the glass shaft and the roller parts, such that the glass shaft and the roller parts may be rotated together with the handle shafts.

The drum may be substantially circular. Each handle shaft may have a curve surface on an outer side thereof and a substantially vertical surface on an inner side thereof. The catching part may have inclined surfaces on both sides thereof.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 is a perspective view showing an exemplary manual window regulator device according to the present invention;

FIG. 2 is a front view showing an exemplary manual window regulator device according to the present invention;

FIG. 3 is a view showing an operation state of an exemplary handle shaft according to present invention at the time of manipulating the handle shaft; and

FIG. 4 is a view showing an operation state of an exemplary glass shaft according to the present invention at the time of manipulating the glass shaft.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A manual window regulator device according to various embodiments of the present invention is a component or device for preventing rotation of a glass shaft outside a vehicle by braking force through a mutual catching and fitting phenomenon of the glass shaft, a handle shaft, and a roller part to solve a problem that the glass is raised or lowered, thereby providing stable braking force and preventing generation of noise.

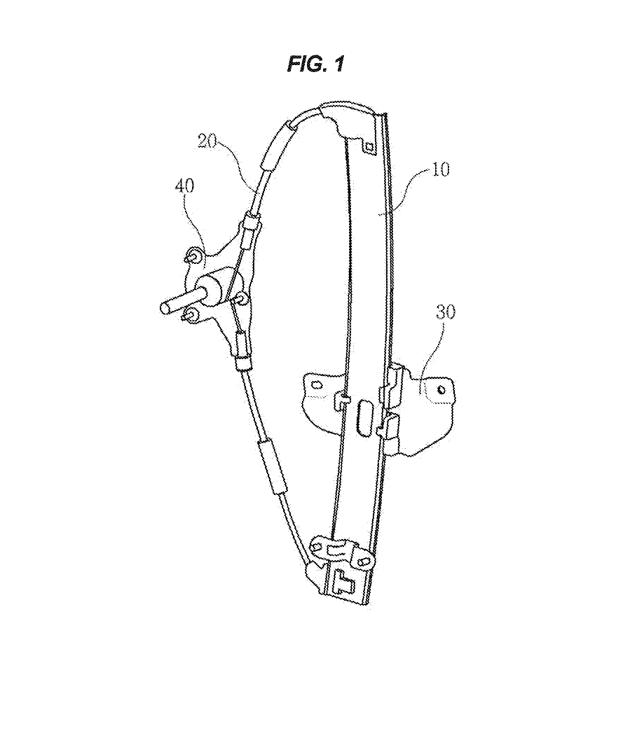

A manual window regulator system according to various embodiments of the present invention, which is to raise or lower glass inside the vehicle, is configured to include a rail 10 provided at a door, a clamp 20 raised or lowered along the rail 10 and mounted with glass, and a manual window regulator device 40 pulling or releasing a cable 30 by operation of a lever provided inside the vehicle to raise or lower the clamp 20, as shown in FIG. 1.

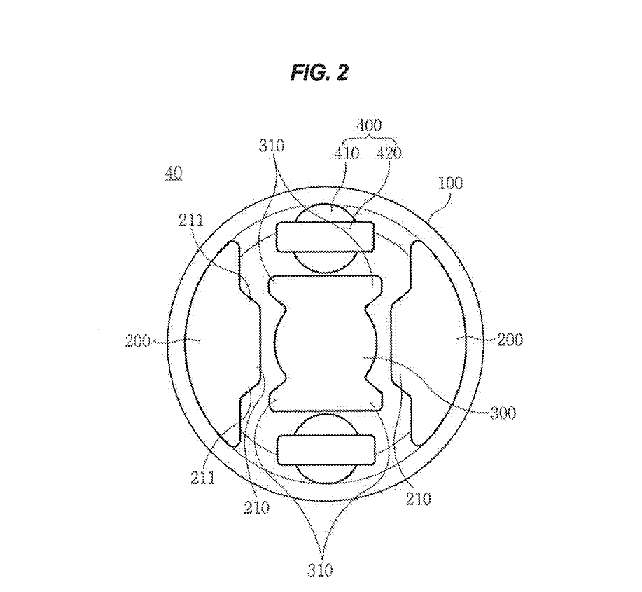

Here, the manual window regulator device according to various embodiments of the present invention is configured to include a drum 100 having a substantially circular shape, handle shafts 200 provided at both sides of an inner portion of the drum 100, respectively, a glass shaft 300 rotatably provided substantially at the center of the drum 100, and roller parts 400 provided at upper and lower portions of the drum 100, respectively, as shown in FIG. 2.

The handle shafts 200 according to various embodiments of the present invention are provided at the left and the right of the inner portion of the drum 100, respectively, so as to be movable along an inner peripheral surface of the drum 100, and have an outer side formed with a curve surface so as to be closely adhered to the inner peripheral surface of the drum 100 and an inner side formed with a substantially vertical surface.

In addition, the handle shaft 200 includes a catching part 210 protrudedly formed substantially at the center of an inner side thereof, and the glass shaft 300 is coupled or fixed to the catching part 210 while being caught by the catching part 210.

Both sides of the catching part 210 are formed with inclined surfaces 211, and end portions of the glass shaft are caught by the inclined surfaces 211 so as to be closely adhered thereto to provide stable fixing force and prevent frictional noise from being generated.

The glass shaft 300 according to various embodiments of the present invention is rotatably provided substantially at the center of the drum 100 and includes protrusion parts 310 formed at both end portions of upper and lower portions thereof, respectively, so as to be caught by the catching parts 210.

The roller parts 400 according to various embodiments of the present invention are provided at the upper or lower or upper and lower portions of the drum 100, respectively, and include a roller 410 and a roller guide 420 into which the roller 410 is rotatably inserted.

An operation state of the manual window regulator device according to various embodiments of the present invention having the above-mentioned configurations will be described below.

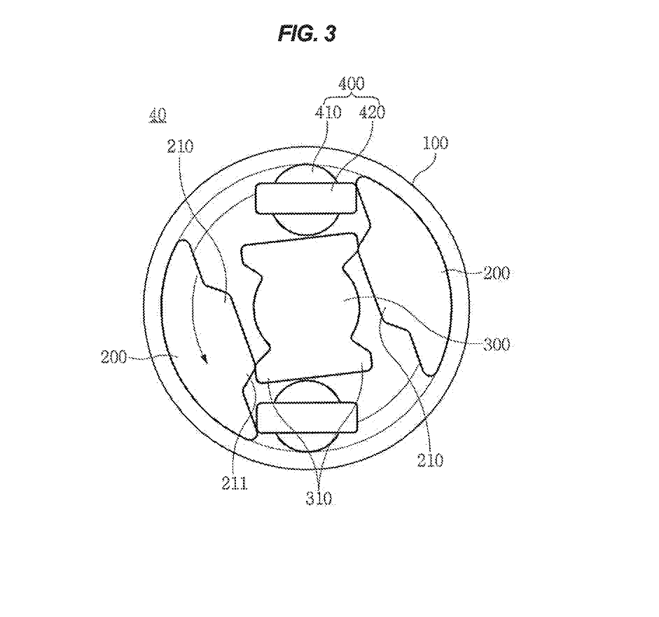

Operation at the time of manipulating handle is illustrated in FIG. 3. As shown, when a passenger manipulates a handle inside the vehicle, the handle shaft 200 is rotated together with the handle. Therefore, the catching part 210 of the handle shaft 200 contacts the protrusion part 310 of the corresponding glass shaft 330, and at the same time, a distal end portion of the handle shaft 200 contacts the roller guide 420 of the roller part 400 to simultaneously rotate the handle shaft 200 and the roller part 400.

In this case, the roller part 400 and the handle shaft 200 are simultaneously rotated, such that the roller part 400 is not fitted between the drum 100 and the handle shaft 200, thereby making it possible to rotate the glass shaft 300. Due to the rotation of the glass shaft 300, the glass is raised or lowered.

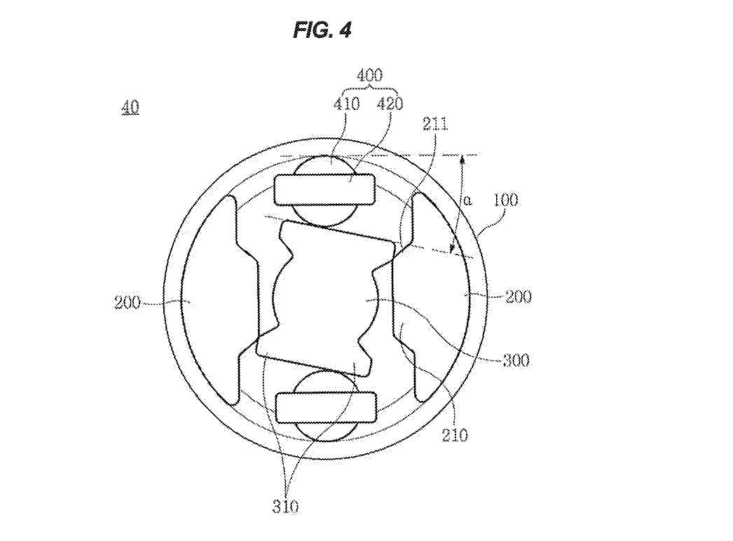

Operation at the time of manipulating glass is illustrated in FIG. 4. As shown, when the glass is manipulated outside the vehicle, it is raised or lowered, such that the glass shaft 300 is rotated. Therefore, the glass shaft 300 is inclined, such that the protrusion part 310 of the glass shaft 300 is supported by one end of the catching part 210 of the corresponding handle shaft 200, and at the same time, the roller 410 of the roller part 400 is fitted between the glass shaft 300 and the drum 100. As a result, the glass shaft 300 is not rotated, but is fixed.

That is, a tangent line between the roller 410 and the drum 100 and a tangent line between the glass shaft 300 and the roller 410 form a wedge shape with an angle α, and the roller 410 is fitted into the wedge shape.

Therefore, the further the glass shaft 300 is rotated, the further the roller 410 is fitted between the drum 100 and the glass shaft 300, such that brake is generated. Therefore, the glass shaft 300 may not be rotated.

According to various embodiments of the present invention, a phenomenon that the glass shaft is rotated outside the vehicle is prevented by stable braking force, thereby making it possible to solve a problem that the glass is raised or lowered and prevent generation of noise.

For convenience in explanation and accurate definition in the appended claims, the terms “upper” or “lower”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A manual window regulator device comprising:
a drum;
handle shafts provided at opposing sides of an inner portion of the drum, each handle shaft including a catching part protruding from an inner side thereof;
a glass shaft rotatably provided substantially at the center of the drum and engaged to the catching parts of the handle shafts while being caught by the catching parts at the time of a left or right turn; and
at least a roller part provided on the drum, and engaging the handle shafts and the glass shaft together while being fitted between the handle shafts and the drum at the time of rotation of the handle shafts at one of the first or right turn so as to rotate the at least a roller part, the handle shaft and glass shaft simultaneously,
wherein the catching parts are protrudedly formed substantially at the center of the inner side of the handle shafts,
wherein the glass shaft includes protrusion parts formed at both distal end portions thereof, respectively, so as to be selectively engaged by the catching parts, and
wherein when a glass is manipulated, the glass shaft is rotated, thereby supporting the protrusion parts of the glass shaft by one end of the catching parts of the corresponding handle shaft, and at the same time, fitting each roller of the at least a roller part between the glass shaft and the drum to stop the glass shaft from being rotated in a reverse direction.

2. The manual window regulator device according to claim 1, wherein the at least a roller part includes the each roller and a roller guide in which the roller each is rotatably provided.

3. The manual window regulator device according to claim 1, wherein when the glass shaft is rotated, the at least a roller part is gradually fitted between the glass shaft and the drum, thereby stopping further rotation of the glass shaft.

4. The manual window regulator device according to claim 1, wherein when the handle shafts are rotated, the handle shafts simultaneously push both of the glass shaft and the at least a roller part, such that the glass shaft and the the at least a roller part is rotated together with the handle shafts.

5. The manual window regulator device according to claim 1, wherein the drum is substantially circular.

6. The manual window regulator device according to claim 1, wherein each of the handle shafts has a curve surface on an outer side thereof and a substantially vertical surface on an inner side thereof.

7. The manual window regulator device according to claim 1, wherein the catching part has inclined surfaces on opposing sides thereof.
